(19) United States
(12) Patent Application Publication
(10) Pub. No.: US 2013/0249490 A1
(43) Pub. Date: Sep. 26, 2013

(54) ESTIMATED CHARGING AMOUNT CALCULATOR OF RECHARGEABLE BATTERY

(71) Applicant: DENSO CORPORATION, Kariya-city (JP)

(72) Inventors: Hisashi UMEMOTO, Tokai-shi (JP); Naomi AWANO, Nagoya (JP)

(73) Assignee: DENSO CORPORATION, Kariya-city (JP)

(21) Appl. No.: 13/846,530

(22) Filed: Mar. 18, 2013

(30) Foreign Application Priority Data
Mar. 22, 2012 (JP) 2012-064837

(51) Int. Cl. H02J 7/00

(52) U.S. Cl. CPC H02J 7/0021
USPC 320/118; 320/128

(57) ABSTRACT

A charge/discharge current Iij where an absolute value of a difference of an estimated value (estimated cell voltage Vije(n)) of a terminal voltage of a battery cell and a detected value (cell voltage Vij(n)) that becomes equal to or less than a prescribed value ΔVth is searched by Newton's method. The charge/discharge current Iij searched in this way is equalized in all the battery cells. A charging rate SOCij(n) of the battery cell is calculated by an integration calculation of a calculated average value Ia (n).

### CROSS-REFERENCE TO RELATED APPLICATION

The application is based on and claims the benefit of priority from earlier Japanese Patent Application No. 2012-64837 filed Mar. 22, 2012, the description of which is incorporated herein by reference.

### TECHNICAL FIELD

The present disclosure relates to an estimated charging amount calculator of a rechargeable battery that calculates a terminal voltage of the rechargeable battery based on a charging rate of the rechargeable battery and a history of a charge/discharge of the rechargeable battery.

### BACKGROUND

As an estimated charging amount calculator, a device for computing a charging rate of an olivine iron group lithium ion rechargeable battery, etc. with high precision is proposed in Japanese Patent Application Laid-Open Publication No. 2010-283922, for example.

Specifically, in this device, a battery voltage is considered as an input, and a charging rate is estimated using a change of an open circuit voltage relative to a charging rate in a region where a rate of a changing speed of the open circuit voltage relative to a change of the charging rate is large, while the charging rate is calculated with an integrated value of a charge/discharge current of a battery in a region where the rate of the changing speed is small.

Thereby, calculation accuracy is maintainable with high precision by a current integration process even in a situation where a calculation accuracy of the charging rate using the change of the open circuit voltage relative to the charging rate falls because the rate of the changing speed has a small region.

However, a detection error arises when detecting a battery current.

Moreover, according to the current integration process, since the detection error is integrated, there is a possibility that the calculation accuracy of the charging rate may fall.

Especially, when the charge/discharge current of the battery becomes large like an in-vehicle battery, there is a possibility that the detection error may also become comparatively large easily; hence the calculation error of the charging rate by integration process may become large.

### SUMMARY

An embodiment provides an estimated charging amount calculator of a rechargeable battery that calculates a terminal voltage of the rechargeable battery based on a charging rate of the rechargeable battery, and a history of the charge/discharge of the rechargeable battery

In an estimated charging amount calculator of a rechargeable battery according to a first aspect, the estimated charging amount calculator includes a terminal voltage estimating means that estimates a terminal voltage of a rechargeable battery based on an estimated charging amount, which is a physical quantity expressing an amount of charge of the rechargeable battery per unit time, and a history of a charge/discharge of the rechargeable battery, a charge/discharge current calculation means that uses a detected value of the terminal voltage of the rechargeable battery as an input, and calculates a charge/discharge current of the rechargeable battery such that an estimated value of the terminal voltage produced by the terminal voltage estimating means approaches to the detected value, an integration process means that accepts the charge/discharge current calculated by the charge/discharge current calculation means as an input, and performs an integration process of the charge/discharge current of the rechargeable battery, and an estimated charging amount calculation means that calculates an estimated charging amount based on an integrated value of the integration process means.

In the disclosure mentioned above, influences of the detection error of the current are avoidable, as compared with a case where a detected value of the charge/discharge current is used directly, by calculating the charge/discharge current using the integration process so that a value estimated by the terminal voltage estimating means may become a value similar to an actual terminal voltage.

In the estimated charging amount calculator of the rechargeable battery according to a second aspect, the charge/discharge current calculation means has a search means that searches for a charge/discharge current where an absolute value of a difference between the estimated value and the detected value becomes equal to or less than a prescribed value.

In the estimated charging amount calculator of the rechargeable battery according to a third aspect, the search means uses the detected value of the charge/discharge current as an input, and when the absolute value of the difference between the estimated value at the time of using the input and the detected value exceeds the prescribed value, the search means searches the charge/discharge current that becomes equal to or less than the prescribed value by correcting the detected value of the charge/discharge current.

In the estimated charging amount calculator of the rechargeable battery according to a fourth aspect, the charge/discharge current calculation means has a feedback means that calculates the charge/discharge current based on an estimated value estimated by the terminal voltage estimating means based on the detected value of the charge/discharge current and a control input that feedback controls a difference of the detected value of the terminal voltage of the rechargeable battery to zero.

In the estimated charging amount calculator of the rechargeable battery according to a fifth aspect, the rechargeable battery has a region where a changing speed of the open circuit voltage relative to a change of a charging rate becomes below a prescribed value, and a region that exceeds the prescribed value, and the estimated charging amount calculation means calculates the estimated charging amount in the region where the changing speed becomes below the prescribed value.

In the estimated charging amount calculator of the rechargeable battery according to a sixth aspect, in an assembled battery as a series-connected object that has a plurality of battery cells, the rechargeable battery is a battery module that is either a single battery cell or a plurality of adjoining battery cells that is a part of the assembled battery, and the integration process means calculates the integrated value of a value acquired by an equalization process of a calculated value for every battery module by the charge/discharge current calculation means.

In the estimated charging amount calculator of the rechargeable battery according to a seventh aspect, the terminal voltage estimating means estimates the terminal voltage based on a model of a power supply that has an open circuit voltage according to a charging rate and an object series-connected with a parallel-connected object of a resistor and a capacitor.

### BRIEF DESCRIPTION OF THE DRAWINGS

In the accompanying drawings:

FIG. 1 shows a diagram of a system configuration in a first embodiment;

FIG. 2 shows a relation between an open circuit voltage of a battery cell and a charging rate in the embodiment;

FIG. 3 shows a flow chart of a calculation process procedure of the charging rate regarding in the embodiment;

FIG. 4 shows a subroutine of the calculation process of the charging rate in the embodiment; and

FIG. 5 shows a subroutine of the calculation process of the charging rate in a second embodiment.

### DETAILED DESCRIPTION OF THE PREFERRED EMBODIMENTS

### The First Embodiment

With reference to the accompanying drawings, hereinafter will be described embodiments of an estimated charging amount calculator of a rechargeable battery applied to an in-vehicle battery.

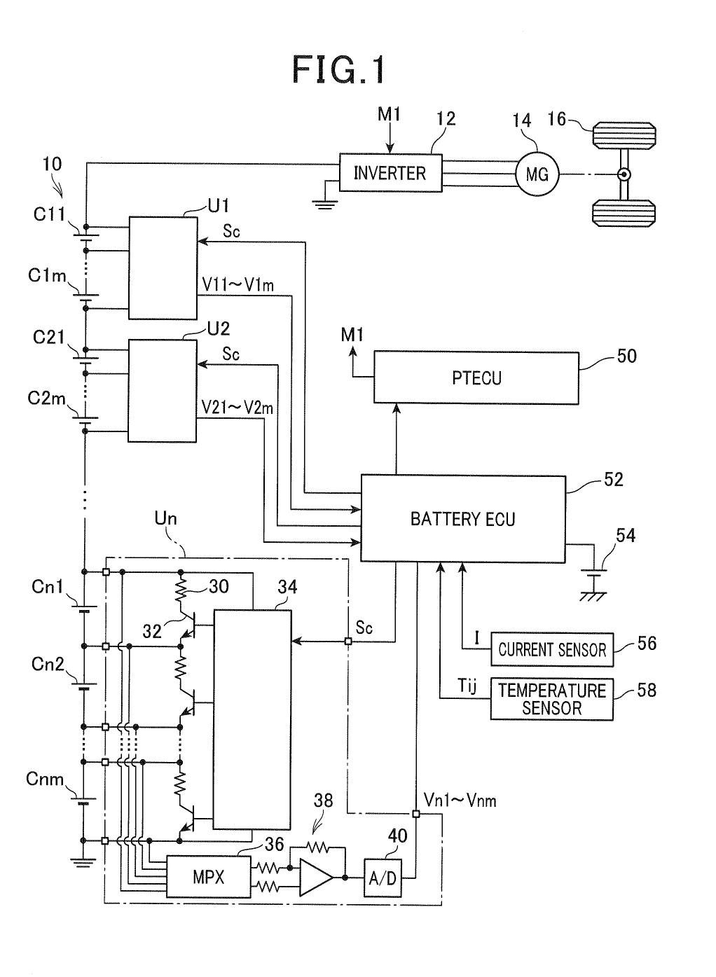

A system configuration of the present embodiment is shown in FIG. 1.

A high-voltage battery 10 shown in FIG. 1 is an assembled battery as a series-connected object that has battery cells C11 to Cnm, and an open circuit voltage thereof becomes, for example, more than 100V.

The battery cell Cij (i=1 to n, j=1 to m) is a lithium ion rechargeable battery.

Each of the battery cells C11 to Cnm have the same composition to each other except for unavoidable individual differences, for example those differences due to the manufacturing process.

That is, a relation of the open circuit voltage relative to a charging rate (SOC: ratio of an actual amount of charge to an amount of fully charged electric charges), the amount of fully charged electric charge And an internal resistance value, etc. are equal for different battery cells.

A motor generator 14 is connected to the high-voltage battery 10 via an inverter 12.

The motor generator 14 is an in-vehicle main engine, and its rotor is mechanically connected with driving wheels 16.

In addition, the motor generator 14 is controlled by a controller (PTECU 50).

The battery cells C11 to Cnm that constitute the high-voltage battery 10 mentioned above are modularized with m (>2) of cells adjoining each other as the same group.

Here, an i-th module consists of battery cells Ci1 to Cim.

A detection unit Ui (i=1 to n) is disposed in each module mentioned above.

Each of the detection units U1 to Un has the same function as each other.

In detail, the detection unit Un, for example, has resistors 30 for electric discharge and switching elements 32 connected in parallel with each of the battery cells Ci1 to Cim, and a discharge controlling section 34 that selectively turns on the switching elements 32.

Moreover, there is provided a multiplexer 36 that selectively applies one of the terminal voltages (cell voltages Vi1 to Vim) of the battery cells Ci1 to Cim to a differential amplifier circuit 38.

Thereby, each terminal voltage of the battery cells Ci1 to Cim is inputted into an analog-to-digital (A/D) converter through the differential amplifier circuit 38, and is thereby converted into digital data.

On the other hand, another controller (battery ECU 52) of the high-voltage battery 10 controls a condition of the high-voltage battery 10 by operating the detection unit Ui.

The battery ECU 52 inputs the digital data (cell voltages Vi1 to Vim) that the A/D converter 40 outputs, and has a function to output a command signal Sc to the discharge controlling section 34 of the detection unit Ui based on the inputted digital data.

Here, the command signal Sc is to command to select which one of the battery cells Ci1 to Cim should be discharged (and when to stop discharging) using the resistors 30 for electric discharge.

In addition, the terminal voltages of the battery ECU and PTECU 50 are both lower than the high-voltage battery 10, and use a low-voltage battery 54, which configures a body electric potential as a standard electric potential, as a power supply.

The battery ECU 52 provides the PTECU 50 information about the allowable maximum output of the high-voltage battery 10 successively based on the cell voltages V11 to Vim mentioned above, a charge/discharge current I of the high-voltage battery 10 detected by a current sensor 56, and the temperature Tij of the battery cell Cij detected by a temperature sensor 58.

Then, based on this information, the PTECU 50 controls controlled variables of the motor generator 14.

In the present embodiment, an olivine iron group lithium ion rechargeable battery is adopted as the battery cell Cij mentioned above.

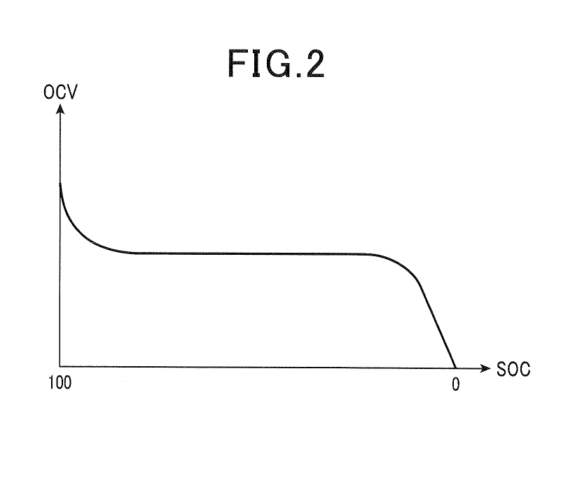

In this case, as shown in FIG. 2, there exists a region (henceforth, plateau region) where a rate of climb of the open circuit voltage (OCV) relative to a rise of the charging rate (SOC) is very small.

Moreover, in the plateau region, a calculation accuracy falls when computing the charging rate based on relevant information of the charging rate and the open circuit voltage with the well-known method.

Accordingly, the fall of the calculation accuracy is avoided by computing the charging rate as follows in the present embodiment.

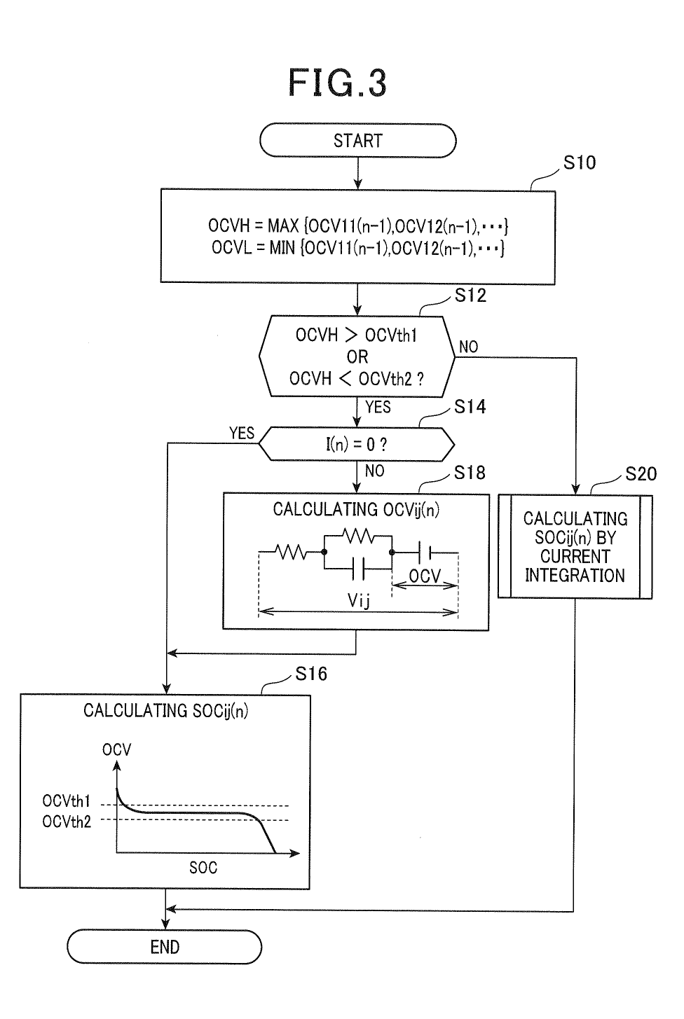

The procedure of calculation process of the charging rate regarding the present embodiment is shown in FIG. 3.

This process is repeatedly performed with a predetermined cycle, for example, by the battery ECU 52.

In this series of processes, last maximum value OCVH and minimum value OCVL of the open circuit voltage OCVij(n−1) about the battery cells C11 to Cnm are first calculated in Step S10.

In the following Step S12, two logical conditions are evaluated. The logical conditions are that (i) the minimum value OCVL is larger than a maximum side threshold value OCVth1 that has a value beyond a boundary value in a maximum side of the plateau region and (ii) that the maximum value OCVH is smaller than a minimum side threshold value OCVth2 that has a value below a boundary value in a minimum side of the plateau region. it is Iecided whether the logical sum of a pair of conditions is true or not.

This process is for computing the open circuit voltage, and for deciding whether calculation accuracy falls when computing the charging rate based on the relevant information of the charging rate and the open circuit voltage.

Then, when an affirmative decision is made in Step S12, it is decided that the charging rate is computable based on the relevant information of the charging rate and the open circuit voltage without causing a fall in accuracy, and the process proceeds to Step S14.

In Step S14, it is decided whether a detected value (charge/discharge current I(n)) of a current detected by the current sensor 56 is approximately zero.

This process is for deciding whether the charging rate is computable based on the relation between the open circuit voltage and the charging rate assuming that the terminal voltage (cell voltage Vij) of each battery cell Cij is the open circuit voltage.

Moreover, when an affirmative decision is made in Step S14, the charging rate SOCij of each battery cell Cij is calculated in Step S16 based on the relation between the open circuit voltage and the charging rate assuming that the cell voltage Vij is the open circuit voltage.

In addition, in fact, even if the charge/discharge current I(n) becomes approximately zero, a gap arises between the cell voltage Vij and the open circuit voltage by polarization for the time being.

For this reason, it is desirable to calculate the charging rate SOCij(n) assuming that the cell voltage Vij is the open circuit voltage after a predetermined period has passed from the charge/discharge current I(n) becoming approximately zero.

On the other hand, when a negative decision is made in Step S14, the process proceeds to Step S18.

In Step S18, the open circuit voltage OCVij(n) is calculated using a model that considers an influence of a voltage drop by internal resistance, or polarization in addition to the open circuit voltage according to the charging rate.

In the present embodiment, the battery cell Cij is modeled as the power supply that has the open circuit voltage mentioned above, a parallel-connected object with a resistor and a capacitor, and a series-connected object with the resistor.

Here, an amount of voltage drop ΔV of the parallel-connected object with the resistor and the capacitor, and an amount of voltage drop of the resistor connected in series with the parallel-connected object mentioned above becomes a difference between the open circuit voltage and the cell voltage Vij.

This process is performed using the cell voltage Vij and the charge/discharge current I(n) as inputs.

That is, the open circuit voltage OCVij is calculated by calculating the amount of voltage drop ΔV etc. mentioned above based on the charge/discharge current I(n), and subtracting these from the cell voltage Vij.

Incidentally, the amount of voltage drop ΔV is not calculated only by this charge/discharge current I(n).

Because, the model includes a capacitor, and the charging voltage of this capacitor depends on a past charge/discharge current.

That is, the open circuit voltage OCVij is calculated based on the cell voltage Vij and the history of the charge/discharge current I(n) in the present embodiment.

However, if the amount of voltage drop ΔV(n) (the charging voltage of the capacitor) this time of the parallel-connected object mentioned above are calculated in this process by a following formula (c1) that uses the previous amount of voltage drop ΔV(n−1), the past charge/discharge currents I(n−1), I(n−2) . . . are not used openly when computing the open circuit voltage OCVij(n) this time.

However, the previous amount of voltage drop ΔV(n−1) becomes a parameter expressing the history of the charge/discharge current in this case.

ΔV(n)=A·ΔV(n−1)+B·I(n) (c1)

In addition, a derivation of the formula (c1) mentioned above is disclosed in the “note” column of the specification.

Incidentally, it is desirable to variably set coefficients A and B according to the temperature Tij of the battery cell Cij.

It is considered that resistance of the resistor and the electrostatic capacity of the capacitor that constitute the parallel-connected object in the model mentioned above have temperature dependency.

When the open circuit voltage OCVij is calculated in this way, the process proceeds to Step S16.

On the other hand, when a negative decision is made in Step S12, the charging rate SOCij is calculated by current integration in Step S20.

In addition, when the processes of Steps S16 and S20 are completed, the series of process is once ended.

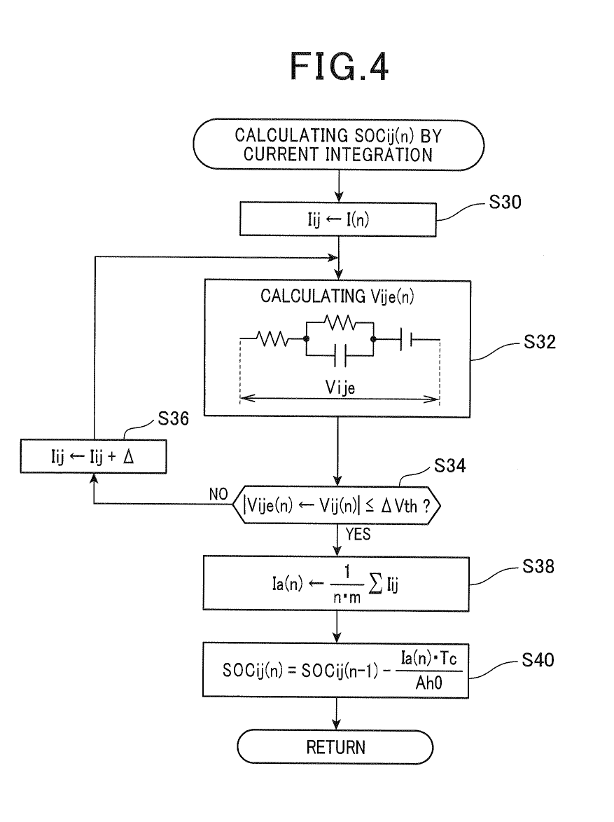

The details of process in Step S20 mentioned above are shown in FIG. 4.

In this series of process, the charge/discharge current Iij of each battery cell Cij is first set as the charge/discharge current I(n) in Step S30.

In the following Step S32, an estimate Vije(n) of the cell voltage Vij is calculated using the model mentioned above.

This is a process that calculates the estimated cell voltage Vije(n) based on the charging rate and the history of charge/discharge current.

That is, the estimated cell voltage Vije(n) can be calculated as a sum of the open circuit voltage and the other open circuit voltage calculated from the relation with the charging rate by inputting an amount of the voltage drop ΔV(n) calculated based on the formula (c1) mentioned above, for example, and the charging rate SOCij(n−1).

This process constitutes a terminal voltage estimating means in the present embodiment.

In the following Step S34, it is decided whether an absolute value of the difference between the estimated cell voltage Vije(n) and the cell voltage Vij(n) becomes equal to or less than a prescribed value ΔVth.

This process is for evaluating the reliability of the charge/discharge current Iij.

That is, if the reliability of the charge/discharge current Iij is high, it is considered that an estimation accuracy of the cell voltage Vij also becomes high, and the difference of the cell voltage Vij(n) and the estimated cell voltage Vije(n) becomes small.

When a negative decision is made in Step S34, the charge/discharge current Iij is corrected only a prescribed amount Δ in Step S36, and it returns to Step S32.

Here, the processes of Steps S32 to S36 are considered as processes that the charge/discharge current Ijj, which sets the estimated cell voltage Vije(n) so that the absolute value of the difference between the estimated cell voltage Vije(n) and the cell voltage Vij(n) becomes equal to or less than a prescribed value ΔVth, is searched by Newton's method

In addition, the processes of Steps S32 to S36 constitute a search means in the present embodiment.

Incidentally, it is considered that the final charge/discharge current Iij obtained by using Newton's method is not different between a case where the process that sets the charge/discharge current Iij a detected value (charge/discharge current I(n)) in Step S30 is prepared and the case where this process is not prepared if there is no restriction of calculation time.

However, the time taken for making the affirmative decision in Step S34 can be shortened by preparing the process of Step S30.

When an affirmative decision is made in Step S34 mentioned above, an average value Ia(n) of all the battery cells Cij of the charge/discharge current Iij is calculated in Step S38.

This process is considered that the charge/discharge current Iij in the case where the affirmative decision is made in Step S34 is not necessarily to be the same to all the battery cells C11 to Cnm.

In the following Step S40, the charging rate SOCij(n) at the present moment is calculated by subtracting Ia·Tc/Ah0, which is obtained by dividing a product of a cycle Tc of the series of process and the average value Ia(n) by an amount of fully charged electric charge Ah0, from the previous charging rate SOCij(n−1).

Here, “Ia·Tc/Ah0” is an amount of change of the charging rate between the cycles Tc.

Moreover, a subtraction process is employed because an electric discharge side of the charge/discharge current Iij is defined as positive.

This process constitutes an integration process means in the present embodiment.

In addition, when the process of Step S40 is completed, the previous process of Step S20 in FIG. 3 is completed.

Incidentally, when the processes shown in FIG. 4 are performed, the open circuit voltage OCVij(n−1) is calculated based on the charging rate SOCij(n) calculated by the process shown in FIG. 4 in Step S10 in FIG. 3, and this may be used in the following cycle.

Thus, according to the present embodiment, instead of computing the charging rate SOCij by integration process of the detected value (charge/discharge current I(n)) of the current sensor 56 in the plateau region, the charging rate SOCij is calculated by using the charge/discharge current Iij at the time when the cell voltage (estimated cell voltage Vije(n)) calculated based on the model approaches the cell voltage Vij.

Thereby, a situation where a detection error of the current sensor 56 is accumulated by the charging rate SOCij can be avoided.

Here, the detection error of the voltage detection means (the differential amplifier circuit 38, the A/D converter 40) of the battery cell Cij can affect the calculation accuracy of the charging rate SOCij(n) in the present embodiment.

However, this influence is considered to be small as compared with the case where the charging rate SOCij(n) is calculated by integrating the detected value of the current sensor 56 according to the following reasons.

First, it is because the detection error of the voltage detection means becomes smaller than the case mentioned above.

The reason is that a range (for example, 1 to 5V) of the voltage targeted for detection of the voltage detection means is smaller compared with a range (for example, 0A to several hundred A) of the current targeted for detection of the current sensor 56.

That is, for this reason, it tends to become easier to make a minimum resolution of the voltage detection means smaller to such an extent that it does not notably contributed to a calculation of the charging rate SOCij(n) than to make a minimum resolution of the current sensor 56 smaller.

Second, it is because there exist a plurality of voltage detection means used for calculating the charging rate SOCij(n).

This is realized by computing the charging rate SOCij(n) based on the average value Ia(n) calculated in Step S38.

That is, in this case, even if the detected value of the voltage detection means in the detection unit U1 has an error that is higher than actual cell voltages V11 to Vim, for example, a probability that all the detected values of the voltage detection means in the other detection units U2 to Un have the same tendency is very low.

For this reason, the influence of the error is reduced.

In addition, an estimation accuracy of the charging rate SOCij(n) shown in FIG. 4 depends on an accuracy of the model used in Step S32.

For this reason, it is desirable that the parameter of this model should be used regularly considering the aging of the high-voltage battery 10.

Hereinafter, some of effects obtained by the present embodiment are disclosed.

(1) When searching the charge/discharge current Iij that makes the estimated cell voltage Vije(n) that has a small absolute value of a difference with the cell voltage Vij(n) by using Newton's method, the charge/discharge current Iij is first configured temporarily to the detected value (charge/discharge current I(n)).

Thereby, the time required for searching the charge/discharge current Iij can be shortened.

(2) The estimated cell voltage Vije(n) is calculated using the model that can individually deal with the open circuit voltage according to the charging rate, the voltage drop of the internal resistance, and the influence of polarization.

Thereby, the time scale of the history of the charge/discharge demanded when computing the terminal voltage by the current integration can be shortened by treating the most histories of the past charge/discharge as the open circuit voltage according to the charging rate.

### The Second Embodiment

Hereinafter, the second embodiment is explained focusing on differences with the first embodiment.

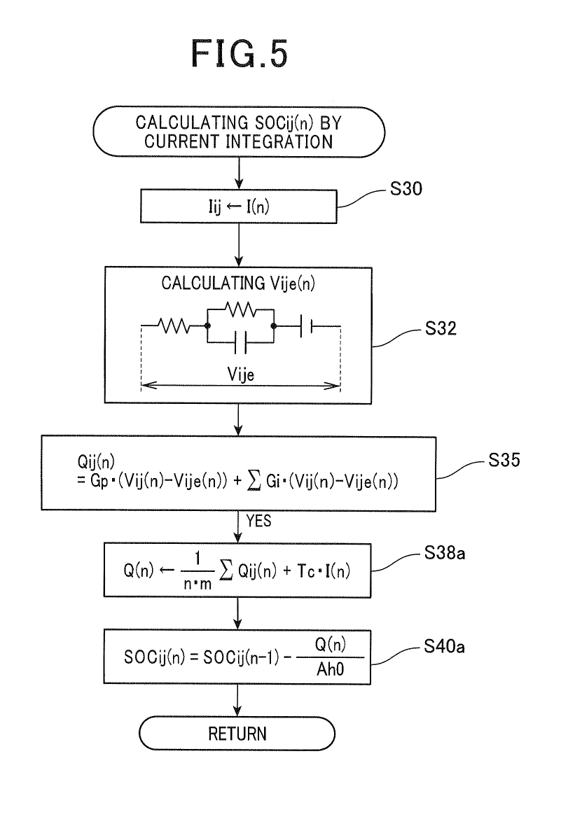

Details of the process of Step S20 in FIG. 3 regarding the present embodiment are shown in FIG. 5.

In addition, in FIG. 5, the same step numbers are given for processes corresponding to the processes shown in FIG. 4.

As shown in FIG. 5, the process proceeds to Step S35 after the estimated cell voltage Vije(n) is calculated in Step S32 in the present embodiment.

In Step S35, a control input Qij(n) for feedback controlling the estimated cell voltage Vije(n) to the cell voltage Vij(n) is calculated.

In the present embodiment, the control input Qij(n) is calculated as a sum of a proportionality element that has a value obtained by subtracting the estimated cell voltage Vije(n) from the cell voltage Vij(n) as an input.

In the following Step S38a, the amount of charge/discharge electric charge Q(n) between a single cycle Tc is configured to be a sum of the average value of the control input Qij(n), and the product of the charge/discharge current I(n) and the cycle Tc.

In addition, the value obtained by dividing the amount of charge/discharge electric charge Q(n) by the cycle Tc corresponds to the average value Ta of the charge/discharge current in Step S38 in FIG. 4.

On the other hand, the amount of charge/discharge electric charge Q(n) is a total amount of the charge/discharge current over the period of the cycle Tc.

Then, in Step S40a, the present charging rate SOCij(n) is calculated by subtracting Q(n)/Ah0, which is obtained by dividing a charge/discharge electric charge quantity Q(n) by fully charged electric charge quantity Ah0, from the previous charging rate SOCij(n−1).

The processes of Steps S35 and S38a mentioned above constitute a feedback means in the present embodiment.

According to the present embodiment explained above, it becomes easy to reduce the operation load for calculating the charge/discharge current by using the control input Qij(n) for feedback controlling the estimated cell voltage Vije(n) to the cell voltage Vij(n).

### Other Embodiments

In addition, each embodiment mentioned above may be modified and performed as follows.

Regarding the search means:

In the first embodiment (Steps S32 to S36 in FIG. 4), although the detected value of the charge/discharge current (charge/discharge current I(n)) is considered as the input, and when the absolute value of the difference between the estimated cell voltage Vije(n) and the cell voltage Vij(n) based on the input exceeds the prescribed value £Vth, the charge/discharge current I(n) is corrected, it is not limited so.

For example, starting with a default value, and the charge/discharge current with the absolute value of the difference between the estimated cell voltage Vije(n) and the cell voltage Vij(n) is below the prescribed value ΔVth may be searched without using the charge/discharge current I(n).

In the first embodiment (Steps S32 to S36 in FIG. 4), although Newton's method is used, it is not limited so.

For example, a secant method may be used.

Regarding the feedback means:

Although the control input for feedback controlling the estimated cell voltage Vije(n) to the cell voltage Vij(n) is configured to the sum of each output of the proportionality element and the integral elements in the second embodiment (Step S35 in FIG. 5), it is not limited so.

For example, the sum of each output of the proportionality element, the integral element, and a derivative element may be considered.

Moreover, for example, only the output of the proportionality element as the control input may be considered.

Regarding the terminal voltage estimating means:

As a model used for estimation, it is not limited only to a model having one parallel-connected object of a resistor and a capacitor, but a model may have two or three, etc., for example.

Moreover, the resistance of the resistor and the capacitance of the capacitor in the model may be variably set according to the charging rate or the charge/discharge current I(n) in addition to temperature.

Moreover, an internal reaction model may be used as disclosed in Japanese Patent Application Laid-Open Publication No. 2008-241246.

That is, although the charge/discharge current is estimated using the internal reaction model based on the detected value of the terminal voltage in the technology disclosed in the Publication No. 2010-283922, if a relational expression of the detected value of the terminal voltage and the charge/discharge current is used here, a means for estimating the terminal voltage can be constituted considering the charge/discharge current as an input.

Regarding the battery cell:

As a battery cell, it is not limited to an olivine iron group lithium ion rechargeable battery.

Furthermore, it is not limited to a lithium ion rechargeable battery, either.

In such a battery, although a changing speed of the open circuit voltage relative to a change of a charging rate can become comparatively large, a process of the charging rate using this relation, and a calculation process of the charging rate by using a current integration process may be used together.

For this reason, in such a case, it is effective to apply the present disclosure to calculation the process of the charging rate by using the current integration process.

Furthermore, in such a battery, there is another reason why application of the present disclosure is effective.

The reason is that the errors do not get accumulated even if the detection accuracy of the voltage sensor is low.

That is, when the voltage sensor sets a voltage higher than an actual voltage as a detected value, for example, the charge/discharge current is calculated larger than the actual condition to match the detected value, thus the charging rate become a value higher than an actual value.

However, as a result, when the voltage exceeds the detected value because the terminal voltage estimated by the terminal voltage estimating means rises, the charge/discharge current is calculated smaller than the actual condition, thus the charging rate does not become a value too high.

Regarding a battery module:

The battery module is not limited only to a battery cell, but adjoining two battery cells or a module Mi may be employed, for example

Regarding a battery pack:

Except for individual differences, it is not limited to the series-connected object of the battery cells Cij having the same composition to each other.

For example, in a situation where auxiliary machinery is connected only to a specific battery cell, it is also possible only for the battery cell to use a battery that has a large amount of fully charged electric charges.

However, the current integration process in this case, it should be cautious that the charge/discharge current is different only in this battery cell.

Regarding the rechargeable battery that is the calculation target of the charging rate:

The rechargeable battery is not limited to the single battery cell or a plurality of adjoining battery cells that constitute the battery pack.

For example, the rechargeable battery may be a lead storage battery (in-vehicle auxiliary machinery battery) whose terminal voltage is about 12V.

Even if in this case, when adopting the current integration process as the calculation process of the charging rate, many situations exist that application of the present disclosure becomes effective.

A first such situation arises because the accuracy of the voltage detection means is higher compared with that of the current sensor.

A second such situation arises when the changing speed of the open circuit voltage relative to the change of the charging rate is comparatively large in all the using regions.

In this case, the reason that application of the present disclosure becomes effective is disclosed in the column “Regarding the battery cell.”

Moreover, it is not limited to the in-vehicle rechargeable battery, either.

Regarding the integration process means:

As exemplified in the first embodiment (Step S38 in FIG. 4) and the second embodiment (Step S38a in FIG. 5), the integration process means is not limited to performing an equalization process of the calculated value produced by the charge/discharge current calculation means.

For example, in the first embodiment, the maximum or the minimum value of the charge/discharge current Iij(n) may be used.

Moreover, the corresponding charge/discharge current

Iij may be the charge/discharge current used for calculating the charging rate SOCij.

Regarding an estimated charging amount calculation means:

Although the charging rate is calculated by integration process when the affirmative decision is made in Step S12 of the embodiment (FIG. 3) mentioned above, it is not limited so.

For example, when the open circuit voltage OCVij is between the upper limit OCVH and the lower limit OCVL for every battery cell Cij, the calculation process of the charging rate SOCij by integration process may be performed.

It is not limited to calculating the charging rate.

For example, considering that the charging rate is obtained by dividing the amount of charge by the amount of fully charged electric charge Ah0, it is clear that it is also possible to calculate the amount of charge itself.

Moreover, as disclosed in the column “Regarding the battery cell”, when using a comparatively large changing speed of the open circuit voltage relative to the charging rate, the open circuit voltage may be calculated as the estimated charging amount.

Others:

The detection means of the terminal voltage (cell voltage Vij) of the battery cell Cij of the high-voltage battery 10 may be common to all the battery cells C11 to Cnm.

In this case, error characteristics of the detection means affect commonly to all the cell voltages V11 to Vnm.

However, even in such a case, if the detection accuracy of the cell voltage Vij is higher than the detection accuracy of the charge/discharge current I(n), the calculation accuracy of the charging rate improves by using the current integration process of the present disclosure, for example.

Remarks:

Hereinafter, derivation of the formula (c1) mentioned above is disclosed.

When the capacitance C of the capacitor in the parallel-connected object of the capacitor and the resistor, and the charging voltage V are used, the charging current becomes CdV/dt.

For this reason, when the resistance R of the resistor is used, the following formula (c2) is formed.

V=R·(−I−CdV/dt) (c2)

When the formula (c2) mentioned above is expanded, it becomes the following formula (c3).

V(n)=−R·I(n)−RC{V(n)−V(n−1)}/Δt (c3)

By solving the formula (c3) mentioned above regarding the charging voltage V(n) and replacing the charging voltage V with the amount of voltage drop ΔV, the formula (c1) can be obtained.

The coefficients A and B may be obtained from the following formulas (c4) and (c5).

A=(C1/Δt)/{(C/Δt)+(1/R)} (c4)

B=1/{(C/Δt)−(1/R)} (c5)

What is claimed is:

1. An estimated charging amount calculator of a rechargeable battery comprising:
a terminal voltage estimating means that estimates a terminal voltage of a rechargeable battery based on an estimated charging amount, which is a physical quantity expressing an amount of charge of the rechargeable battery per unit time, and a history of a charge/discharge of the rechargeable battery;
a charge/discharge current calculation means that uses a detected value of the terminal voltage of the rechargeable battery as an input, and calculates a charge/discharge current of the rechargeable battery such that an estimated value of the terminal voltage produced by the terminal voltage estimating means approaches to the detected value;
an integration process means that accepts the charge/discharge current calculated by the charge/discharge current calculation means as an input, and performs an integration process of the charge/discharge current of the rechargeable battery; and
an estimated charging amount calculation means (S40, S40a) that calculates an estimated charging amount based on an integrated value of the integration process means.

2. The estimated charging amount calculator of the rechargeable battery according to claim 1, wherein,
the charge/discharge current calculation means has a search means that searches for a charge/discharge current where an absolute value of a difference between the estimated value and the detected value becomes equal to or less than a prescribed value.

3. The estimated charging amount calculator of the rechargeable battery according to claim 2, wherein,
the search means uses the detected value of the charge/discharge current as an input, and when the absolute value of the difference between the estimated value at the time of using the input and the detected value exceeds the prescribed value, the search means searches the charge/discharge current that becomes equal to or less than the prescribed value by correcting the detected value of the charge/discharge current.

4. The estimated charging amount calculator of the rechargeable battery according to claim 1, wherein,
the charge/discharge current calculation means has a feedback means that calculates the charge/discharge current based on an estimated value estimated by the terminal voltage estimating means based on the detected value of the charge/discharge current and a control input that feedback controls a difference of the detected value of the terminal voltage of the rechargeable battery to zero.

5. The estimated charging amount calculator of the rechargeable battery according to claim 1, wherein,
the rechargeable battery has a region where a changing speed of the open circuit voltage relative to a change of a charging rate becomes below a prescribed value, and a region that exceeds the prescribed value, and
the estimated charging amount calculation means calculates the estimated charging amount in the region where the changing speed becomes below the prescribed value.

6. The estimated charging rate calculator of the rechargeable battery according to claim 1, wherein,
in an assembled battery as a series-connected object that has a plurality of battery cells, the rechargeable battery is a battery module that is either a single battery cell or a plurality of adjoining battery cells that is a part of the assembled battery, and
the integration process means calculates the integrated value of a value acquired by an equalization process of a calculated value for every battery module by the charge/discharge current calculation means.

7. The estimated charging rate calculator of the rechargeable battery according to claim 1, wherein,
the terminal voltage estimating means estimates the terminal voltage based on a model of a power supply that has an open circuit voltage according to a charging rate and an object series-connected with a parallel-connected object of a resistor and a capacitor.
